(19) United States
(12) Patent Application Publication
(10) Pub. No.: US 2015/0227943 A1
(43) Pub. Date: Aug. 13, 2015

(54) System and Method for Documenting Regulatory Compliance

(71) Applicant: Qvolve, LLC, Kalamazoo, MI (US)

(72) Inventor: Alan P. Radomsky, Kalamazoo, MI (US)

(21) Appl. No.: 14/617,857

(22) Filed: Feb. 9, 2015

Related U.S. Application Data
(60) Provisional application No. 61/937,290, filed on Feb. 7, 2014.

(51) Int. Cl. G06Q 30/00

(52) U.S. Cl. CPC G06Q 30/018

(57) ABSTRACT

A computer implemented system and method using a mobile device having a processor for displaying results of regulatory compliance tests configured to perform the steps of: displaying a first data field in the mobile application for allowing the entry of a handwritten value. Comparing a numerical result to that determined from the handwritten value against an expected numerical value. Displaying a final value based on the step of comparing in a second data field where the application indicates if the manufacturing compliance test is compliant based upon the final value.

### CROSS-REFERENCE TO RELATED APPLICATIONS

This application claims priority under 35 U.S.C. §119(e) to U.S. Provisional Application Ser. No. 61/937,290 filed Feb. 7, 2014 assigned to Qvolve, LLC.

### FIELD OF THE INVENTION

The present invention relates generally to a method of documenting manufacturing production compliance with medical devices and pharmaceuticals and more specifically for manufacturers being regulatory compliant with government rules and regulations.

### BACKGROUND

Compliance with government regulations, such as those with the United States Federal Food and Drug Administration (FDA) is mandated in pharmaceutical and medical device manufacturing facilities worldwide. In such jurisdictions, regulatory compliance is required in facilities that manufacture regulated products that are marketed and sold in the United States regardless of where the manufacturing facility is located. The difficulty and importance in meeting compliance criteria is often underestimated. Accordingly, systems and methods for meeting FDA compliance are welcomed in making this burdensome task easier for the manufacturer.

### SUMMARY OF THE INVENTION

Embodiments of the present invention include a communications system for performing manufacturing regulatory compliance that include at least one mobile device in wireless communication with at least one server using a processor executing a mobile application and configured to perform the steps of a) displaying in a first field in a mobile application the entry of a handwritten value; b) comparing a numerical result prompted by a handwritten value against an expected numerical value stored in memory or provided by the at least one server; c) determining a final value based on the step of comparing; and d) displaying in a second field whether the manufacturing compliance test is regulatory complaint based upon the final value. The expected numerical value is derived from at least one of manufacturing equipment, lab equipment, testing equipment, a programmable logic controller, facility/utilities data and hand held instrumentation where the at least one mobile device wirelessly communicates with the at least one server.

In still other embodiments, a method is described using a mobile device having at least one processor for providing results of a manufacturing compliance test configured to at least perform the steps of: a) displaying a first field in the mobile application for allowing the entry of a handwritten value; b) comparing a numerical result determined from the handwritten value against an expected numerical value; c) determining a final value based on the step of comparing; and d) displaying a second field indicating if the manufacturing compliance test is compliant based upon the final value. In still other embodiments, a method is described for determining manufacturing regulatory compliance configured to at least execute and/or perform the steps of: a) providing at least one mobile device having a processor for executing a software application; b) displaying at least one field in the mobile application for providing handwritten information about the results of a regulatory compliant test; c) comparing a numerical result of the handwritten information to an expected result to provide a final result; and d) providing a second field indicating whether the regulatory compliance test has passed or failed based upon the final result.

Still further embodiments include a method for determining manufacturing compliance utilizing a mobile device having a display and at least one processor for executing a software application configured to perform the steps of: a) identifying a specific manufacturing quality test to be performed; b) providing a first data field in the software application for displaying the name of the test; c) determining an acceptance criteria for the specific manufacturing quality test; d) providing a second data field in the software application for entering a handwritten result of the manufacturing quality test; e) converting the handwritten result to a determined value; f) providing a third data field in the software application for displaying an expected value for the manufacturing quality test; g) providing a fourth data field in the software application for entering at least one handwritten initial of persons performing the manufacturing quality test; h) providing a fifth data field in the software application for entering at least one handwritten initial for individuals verifying that the manufacturing quality test has been performed; i) providing a sixth data field for displaying the determined numerical value that is responsive to entry of the at least one handwritten initial; j) comparing the determined numerical value to the expected numerical value; and k) providing a seventh data field indicating a pass or fail indication based upon the step of comparing. Such that the specific manufacturing quality test is a regulatory test mandated by law. The third field may also be used for providing an above or below indicia of a test result. The pass or fail indication is color coded for identification. The pass indication is color coded green and the fail indication is color coded red. More specifically, the fifth data field may include a time and date stamp when the at least one handwritten initial was made and the sixth data field may also include a time and date stamp when the at least one handwritten initial was made.

Finally, still other embodiments include a method of documenting regulatory compliance comprising the steps of: utilizing a communications system that allows for hybrid documentation for transmitting the hybrid documentation to at least one portable electronic device; and producing hybrid documentation by combining handwritten data with at least one electronic data collection device. Further, a method for documenting regulatory compliance in a manner using hybrid documentation include the steps of: utilizing an electric device to communicate with the wireless communication system in a bidirectional manner; and executing documentation by an operator in bidirectional communication with the communications system such that the documentation data is received from the communications system; and transmitting data to the communications system at appropriate times as specified by the documentation being executed where the step of executing documentation includes the step of gathering and collecting data.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a system for documenting regulatory manufacturing compliance.

FIG. 2 is a block diagram illustrating an electronic portable device used in connection with embodiment of the invention.

FIG. 3 is flowchart diagram illustrating a method used in documenting regulatory manufacturing compliance.

FIG. 4 is a screen shot diagram illustrating a method for compliance with regulatory manufacturing test standards in accordance with an embodiment of the invention.

FIG. 5 is a block diagram illustrating a system for documenting a batch record using an electronic portable device.

FIG. 6 is a block diagram illustrating a system for providing data transfer between a process documentation system and a corporate data system.

FIG. 7 is a block diagram illustrating a system for providing data transfer between a process system and a process documentation system.

FIG. 8 illustrates a communications system and method where wireless devices are utilized for communication and data capture by a process documentation system.

FIG. 9 is a block diagram illustrating the use of a wireless transmitter attached to a device used to provide data transfer of device location to the process documentation system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for documenting regulatory manufacturing compliance. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of FDA manufacturing compliance described herein. The non-processor circuits may include, but are not limited to, a radio receiver, a radio transmitter, signal drivers, clock circuits, power source circuits, and user input devices. As such, these functions may be interpreted as steps of a method to perform method of FDA manufacturing compliance. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The disclosure generally relates to an electronic systems and devices, such as a portable electronic device or non-portable electronic device. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, electronic navigation devices, and so forth. The portable electronic device may be a portable electronic device without wireless communication capabilities, such as handheld electronic games, digital photograph albums, digital cameras, media players, e-book readers, and so forth. Examples of non-portable electronic devices include desktop computers, electronic white boards, smart boards utilized for collaboration, built-in monitors or displays in furniture or appliances, and so forth.

Title 21 of the United States Code of Federal Regulations governs food and drug (and medical device) regulations established by the Federal Drug Administration (FDA) and other agencies in the U.S. Included in Part 211 of this title, are regulations on Good Manufacturing Practices (GMP) for production of food, pharmaceuticals and medical devices. These regulations are laid down with the intention of providing minimum requirements that a pharmaceutical or a food product manufacturer must meet while manufacturing drugs or food products, which then assures that the products manufactured/produced are of high quality and do not pose any risk to the consumer or public. Good manufacturing practice regulations provide guidance for manufacturing, testing, and quality assurance in order to ensure that drug product is safe for human consumption. Many countries have legislated that pharmaceutical and medical device manufacturer must follow GMP, and have created their own GMP regulations that correspond with their legislation. Basic concepts of all of these regulations remain more or less similar to the ultimate goals of safeguarding the health of the patient as well as producing good quality medicine, medical devices or active pharmaceutical ingredients. In the United States, a drug may be deemed “adulterated” even though it has passed all of the specifications tests if it is found to be manufactured in a facility or condition which violates or does not comply with current good manufacturing regulations. Therefore complying with GMP is a mandatory aspect in pharmaceutical and medical device manufacturing.

Although there are a number of them, all guidelines follow a few basic principles: Hygiene: Manufacturing facilities must maintain a clean and hygienic manufacturing area. Environmental conditions are controlled as necessary for the product being produced. Manufacturing processes are clearly defined and controlled. All critical processes are validated to ensure consistency and compliance with specifications. Manufacturing processes are controlled, and any changes to the process are evaluated. Changes that have an impact on quality are prospectively validated as necessary.

Instructions and procedures are written in clear and unambiguous language. Operators are trained to carry out and document procedures. Records are made, manually or by instruments, during manufacture that demonstrate that all the steps required by the defined procedures and instructions were in fact taken and that the quantity and quality of the product was as expected. Deviations are investigated and documented. Records of manufacture (including distribution) that enable the complete history of a batch or device to be traced are retained in a comprehensible and accessible form. The distribution of the product minimizes any risk to its quality. A system is available for recalling any product from sale or supply. Complaints and adverse events about marketed products are examined, the causes of quality defects are investigated, and appropriate measures are taken with respect to the defective products and to prevent recurrence.

GMP regulations are not prescriptive instructions on how to manufacture products. Instead, they are a series of general principles that must be observed during manufacturing. When a company is setting up its quality program and manufacturing process, there may be many ways it can fulfill GMP requirements. It is the company's responsibility to determine the most effective and efficient quality process. Thus, an embodiment of the present invention works to enable an efficient and cost effective quality process by marrying both the combination of electronic data with handwritten data in a mobile application.

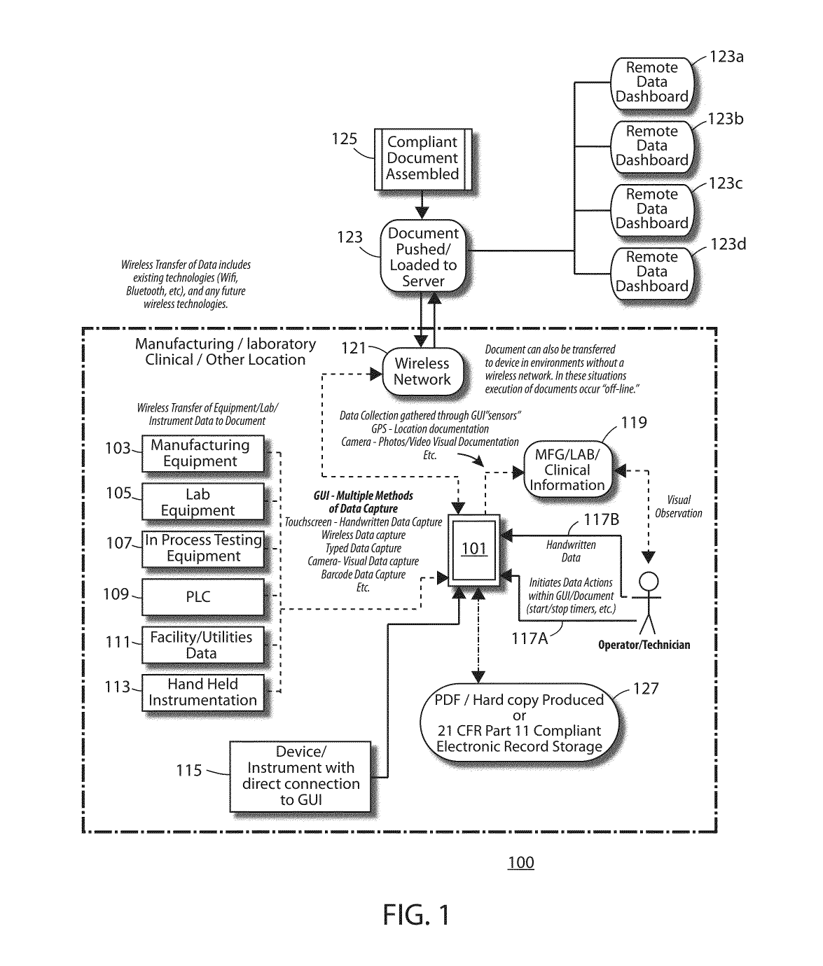

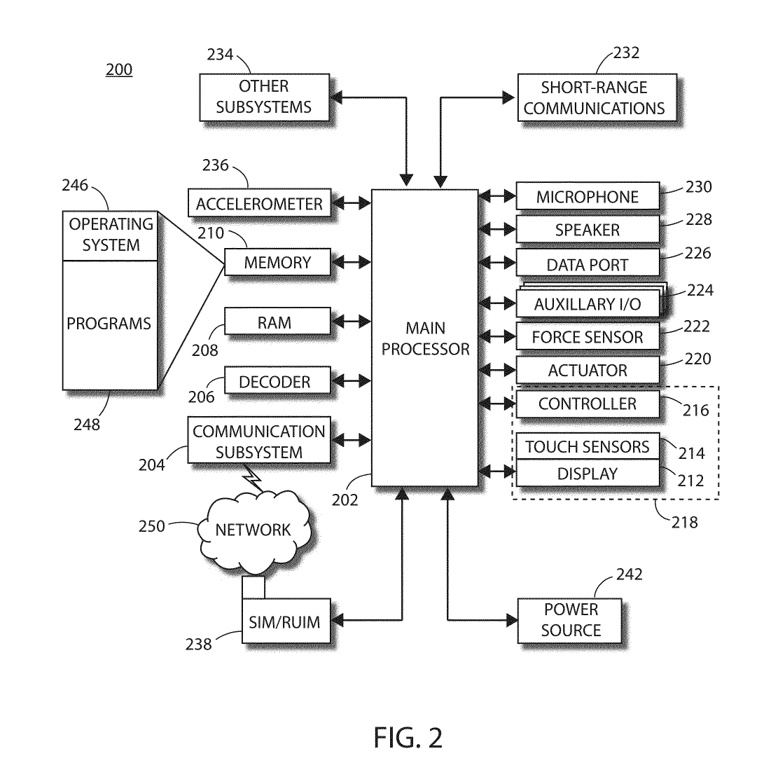

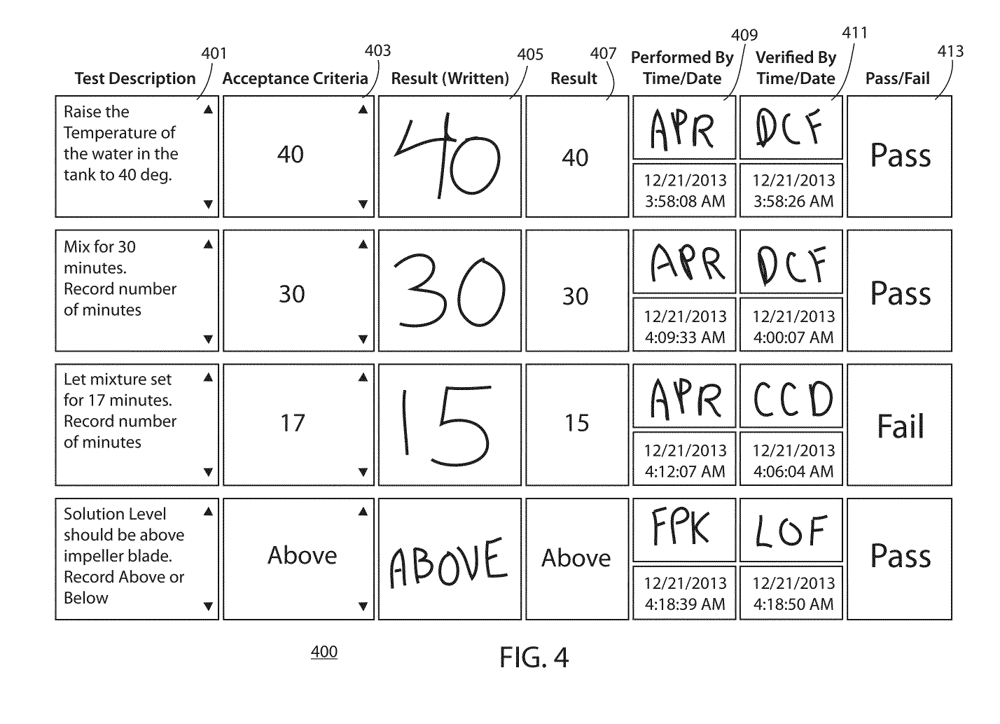

FIG. 1 is a block diagram illustrating a communications system for documenting FDA manufacturing compliance using a computer implemented method. The communications system 100 includes a mobile electronic device 101 for entering and capturing data. The mobile electronic device 101 is like that shown and described with regard to FIG. 2 hereinafter. Those skilled in the art will recognize that the mobile electronic device 101 includes multiple methods and apparatus of data capture. These include but are not limited to a touch screen for handwritten data capture, a wireless data capture, typed data capture, a camera for visual data capture, and a barcode data capture. As described herein, an important aspect of various embodiments of the invention is “hybrid documentation” which combines aspects of both handwritten data entry and the other forms of data capture as set forth herein. In one embodiment, the mobile device 101 can work to capture the wireless transfer of electronic lab and instrument data for populating fields of a document that is displayed on the mobile app. For example, such a document might be like that illustrated in FIG. 4. Those skilled in the art will recognize that the equipment and lab instruments wirelessly transmitting such data may be located in a manufacturing facility, laboratory and/or clinical facility. The types of equipment located in such facilities may include but is not limited to manufacturing equipment 103, lab equipment 105, in process testing equipment 107, programmable logic controller (PLC) 109, a facility/utility data server 111 and hand held instrumentation 113. Additionally, devices and/or instruments with direct connection to the graphical user interface 115 may be connected to the mobile device 101.

In still another embodiment, the user may initiate data actions within the graphical user interface document such as utilizing using start/stop timers, starting data collection from a specific instrument, documenting testing location via GPS sensors, etc. 117a. The user may also provide handwritten data 117b to the mobile device 101. The handwritten data may be supplied to the touch screen display using a finger, stylist or other tool that can be used to capture handwritten movements. For example, the user may also gather visual information observed from the manufacturing/lab/clinical environment 119. The device 101 displays data from the environment gathered through the graphic user interface (GUI) sensors but may also display Global Positioning System (GPS) location information or camera photo and/or video visual documentation. Those skilled in the art will recognize that environment 119 represents an entire “compliance environment” in which the operator is operating. Thus, the operator utilizes his senses to observe the environment 119 to determine the appropriate interaction with the mobile device 101. The device can also collect data on the environment via its sensors.

In use, the wireless device 101 is configured to operate and communicate wirelessly with a wireless network 121. The wireless transfer of data may include but is not limited to Wi-Fi, Zig Bee, and Bluetooth etc. and any future wireless technologies. The wireless network 121 can transfer documents directly to the wireless device 101 and/or other environments without a wireless network. In those situations, execution of electronic documents occur “off-line” and then are electronically transmitted or synced at some time when data connections are available. The wireless network 121 may also communicate bi-directionally with electronic documents pushed and/or loaded to a storage memory such as remote server 123. Those skilled in the art will recognize that only compliant documents are assembled 125 and then transferred to the remote server 123. As seen in FIG. 1, one or more remote data dashboards 123a, 123b, 123c, 123d can be used with the remote server 123. The remote data dashboards can operate as remote computer or Unix terminals enabling users the ability to read and write data to the remote server 123 or as a visual representation of current process status. Finally, data from the wireless device 101 can be printed in a PDF hardcopy 127 or other types of digital formats that are 21 CFR Part 11 compliant regarding electronic record storage.

FIG. 2 is a block diagram illustrating an example of a portable electronic device 200. The portable electronic device 200 includes multiple components, such as a processor 202 that controls the overall operation of the portable electronic device 200. Communication functions, including data and voice communications, are performed through a communication subsystem 204. Data received by the portable electronic device 200 is decompressed and decrypted by a decoder 206. The communication subsystem 204 receives messages from and sends messages to a wireless network 250. The wireless network 250 may be any type of wireless network, including, but not limited to, data wireless networks, voice wireless networks, and networks that support both voice and data communications. A power source 242, such as one or more rechargeable batteries or a port to an external power supply, powers the portable electronic device 200.

The processor 202 interacts with other components, such as a Random Access Memory (RAM) 208, memory 210, a touch-sensitive display 218, one or more actuators 220, one or more force sensors 222, an auxiliary input/output (I/O) subsystem 224, a data port 226, a speaker 228, a microphone 230, short-range communications 232 and other device subsystems 234. The touch-sensitive display 218 includes a display 212 and touch sensors 214 that are coupled to at least one controller 216 that is utilized to interact with the processor 202. Input via a graphical user interface is provided via the touch-sensitive display 218. Information, such as text, characters, symbols, images, icons, and other items that may be displayed or rendered on a portable electronic device, is displayed on the touch-sensitive display 218 via the processor 202. The processor 202 may also interact with an accelerometer 236 that may be utilized to detect direction of gravitational forces or gravity-induced reaction forces.

To identify a subscriber for network access, the portable electronic device 200 may utilize a Subscriber Identity Module or a Removable User Identity Module (SIM/RUIM) card 238 for communication with a network, such as the wireless network 250. Alternatively, user identification information may be programmed into memory 210.

The portable electronic device 200 includes an operating system 246 and software programs, applications, or components 248 that are executed by the processor 202 and are typically stored in a persistent, updatable store such as the memory 210. Additional applications or programs may be loaded onto the portable electronic device 200 through the wireless network 250, the auxiliary I/O subsystem 224, the data port 226, the short-range communications subsystem 232, or any other suitable subsystem 234.

A received signal such as a text message, an e-mail message, or web page download is processed by the communication subsystem 204 and input to the processor 202. The processor 202 processes the received signal for output to the display 212 and/or to the auxiliary I/O subsystem 224. A subscriber may generate data items, for example e-mail messages, which may be transmitted over the wireless network 250 through the communication subsystem 204. For voice communications, the overall operation of the portable electronic device 200 is similar. The speaker 228 outputs audible information converted from electrical signals, and the microphone 230 converts audible information into electrical signals for processing.

The touch-sensitive display 218 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. A capacitive touch-sensitive display includes one or more capacitive touch sensors 214. The capacitive touch sensors may comprise any suitable material, such as indium tin oxide (ITO).

One or more touches, also known as touch contacts or touch events, may be detected by the touch-sensitive display 218. The processor 202 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 218. For example, the x location component may be determined by a signal generated from a first touch sensor, and the y location component may be determined by a signal generated from a second touch sensor. A touch may be detected from any suitable input member, such as a finger, thumb, appendage, or other objects, for example, a stylus (active or passive), pen, or other pointer, based on the nature of the touch-sensitive display 218. Multiple simultaneous touches may be detected.

One or more gestures may also be detected by the touch-sensitive display 218. A gesture, such as a swipe, also known as a flick, is a particular type of touch on a touch-sensitive display 218 and may begin at an origin point and continue to an end point, for example, a concluding end of the gesture. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The optional actuator(s) 220 may be depressed or activated by applying sufficient force to the touch-sensitive display 118 to overcome the actuation force of the actuator 220. The actuator(s) 220 may be actuated by pressing anywhere on the touch-sensitive display 218. The actuator(s) 220 may provide input to the processor 202 when actuated. Actuation of the actuator(s) 220 may result in provision of tactile feedback. When force is applied, the touch-sensitive display 218 is depressible, pivotable, and/or movable. Such a force may actuate the actuator(s) 220. The touch-sensitive display 218 may, for example, float with respect to the housing of the portable electronic device, i.e., the touch-sensitive display 218 may not be fastened to the housing. A mechanical dome switch actuator may be utilized. In this example, tactile feedback is provided when the dome collapses due to imparted force and when the dome returns to the rest position after release of the switch. Alternatively, the actuator 220 may comprise one or more piezoelectric (piezo) devices that provide tactile feedback for the touch-sensitive display 218.

Optional force sensors 222 may be disposed in conjunction with the touch-sensitive display 218 to determine or react to forces applied to the touch-sensitive display 218. The force sensor 222 may be disposed in line with a piezo-actuator 220. The force sensors 222 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities. Optionally, force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

The touch-sensitive display 218 includes a display area in which information may be displayed, and a non-display area extending around the periphery of the display area. The display area generally corresponds to the area of the display 212. Information is not displayed in the non-display area by the display, which non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 212 in the non-display area. Optionally, a secondary display, not part of the primary display 212, may be disposed under the non-display area. Touch sensors may be disposed in the non-display area, which touch sensors may be extended from the touch sensors in the display area or may be distinct or separate touch sensors from the touch sensors in the display area. A touch, including a gesture, may be associated with the display area, the non-display area, or both areas. The touch sensors may extend across substantially the entire non-display area or may be disposed in only part of the non-display area. In still other embodiments, verification of the user or verifying may be made using biometric data including but not limited to facial recognition using a camera on the electronic device or a field for capturing a user or verifier finger print. Those skilled in the art will recognize that such confirmation of identity can work to ensure that only authorized persons are conducting or verifying regulatory tests displayed using the app on the device.

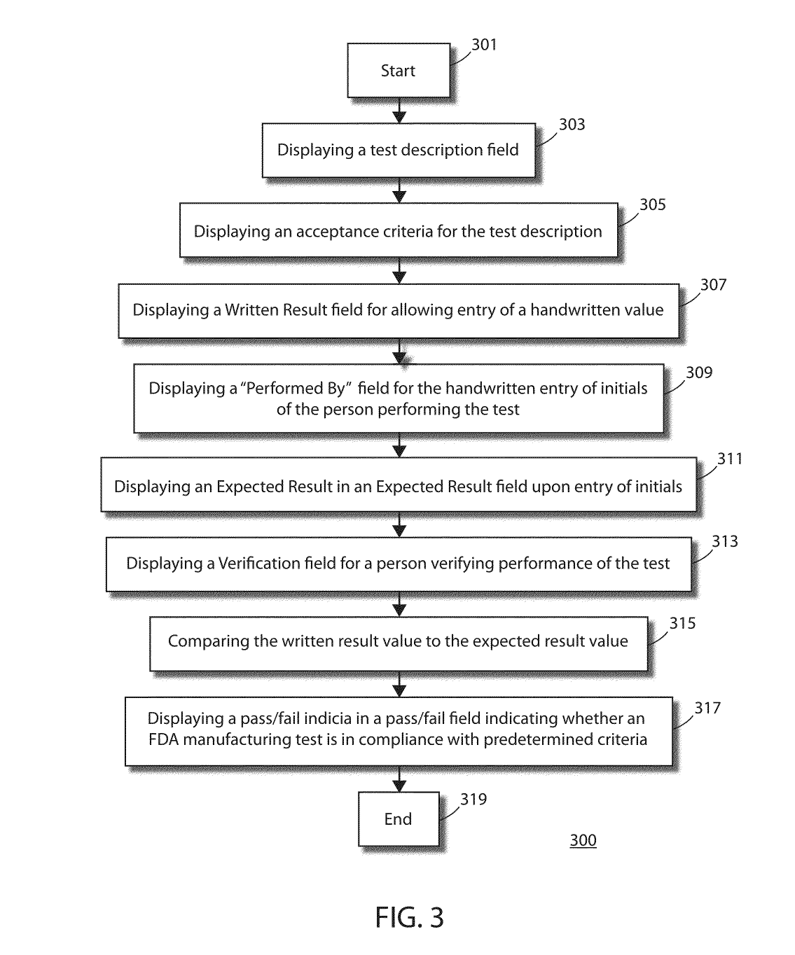

FIG. 3 is flowchart diagram illustrating a method used in documenting regulatory manufacturing compliance 300 such as FDA compliance. FIG. 4 is a screen shot diagram 400 illustrating a method for compliance with a regulatory manufacturing test standards in accordance with FIG. 3. Referring to both FIGS. 2 and 3, the process starts/begins 301 where a test description data field is displayed 303. As seen in FIG. 4, the test description data field 401 indicates a test step used in a specific manufacturing compliance test. Those skilled in the art will recognize that this may include any type of method steps used in connection with the regulatory compliance test. For example, raising or lowering water temperature, mixing liquids for a specific period of time, allowing a mixture to set, or indicating whether a solution is either above or below a specific level or component such as an impeller blade. As the test description data field 401 is displayed 303, an acceptance criteria field 403 for each specific test description is also displayed 305 adjacent to the test description data field 403. The acceptance criteria is generally a numeric value that is set and/or specified in compliance with governmental regulatory standards for meeting some predetermined acceptable level. For example, in the case where a water temperature is raised, it may be raised to a predetermined level such as 40° F. (4° C.). After the acceptance criteria is displayed, a written result data field 405 is displayed adjacent to the acceptance criteria field for allowing entry of a handwritten value 307. The handwritten value may be entered into the appropriate written result data field 405 for each individual test description. As will be evident to those skilled in the art, the handwritten value may be manually entered by the user/operator using a tablet stylist, user's finger or other mechanical or electronic device. In order to be sure the written result 405 is accurate and not inadvertently fabricated, the test description data field (acceptance criteria) 403 may be masked or not displayed until all of the written result data field 405 entries have been entered.

The user may then enter another handwritten value 307, in a “performed by” data field 409 that is displayed in the mobile app. This “performed by” data field 409 is primarily used for the entry of handwritten initials of the person performing the test 309. This data field may also be optimally split and/or divided in a manner for allowing the user to enter their handwritten initials. A separate portion of this “performed by” data field 409 may also be dedicated to a timestamp that can include but is not limited to the date and calendar year as well as the hour, minute and seconds of the day upon which the initials were entered. Once the user has entered their initials 309, an “expected result” data field 407 is populated and prompted by the user entering their initials. This “expected result” data field 407 is typically some numerical value stored in memory and/or cloud that is based on the expected results of the particular manufacturing test being performed. Those skilled in the art will recognize that not all values for various regulatory tests are numerical and other alpha or alphanumeric characters may also be used. Thus, it is entry of the operators initials in the “performed by” data field 409 that prompts the display of the expected results 311. This value is generally not an optical characteristic recognition (OCR) display of the written result that is entered by the user or operator into the “written result” data field 405. Those skilled in the art will also recognize the process can also be configured to populate the expected result data field 407 after entry of initials into a “verification” field described herein.

Thereafter, a “verification” field 411 is used for those persons following up and verifying results of the test performed and displayed 313. The verification field may also be a divided data field where the verifying person can enter their initials in one portion of the field while a second portion is dedicated to a timestamp for displaying the calendar year date, as well as the hour, minute and second of the day. After entry of the user's initials of the verification 313, the written result value is compared to the expected result value 315. A pass/fail condition in a pass/fail field is displayed 413 which indicates whether the FDA manufacturing test is in compliance with the predetermined criteria 317. The pass/fail test font may be color-coded for easier identification by the user. Finally, the test ends with the indication of the pass/fail in the appropriate field 319.

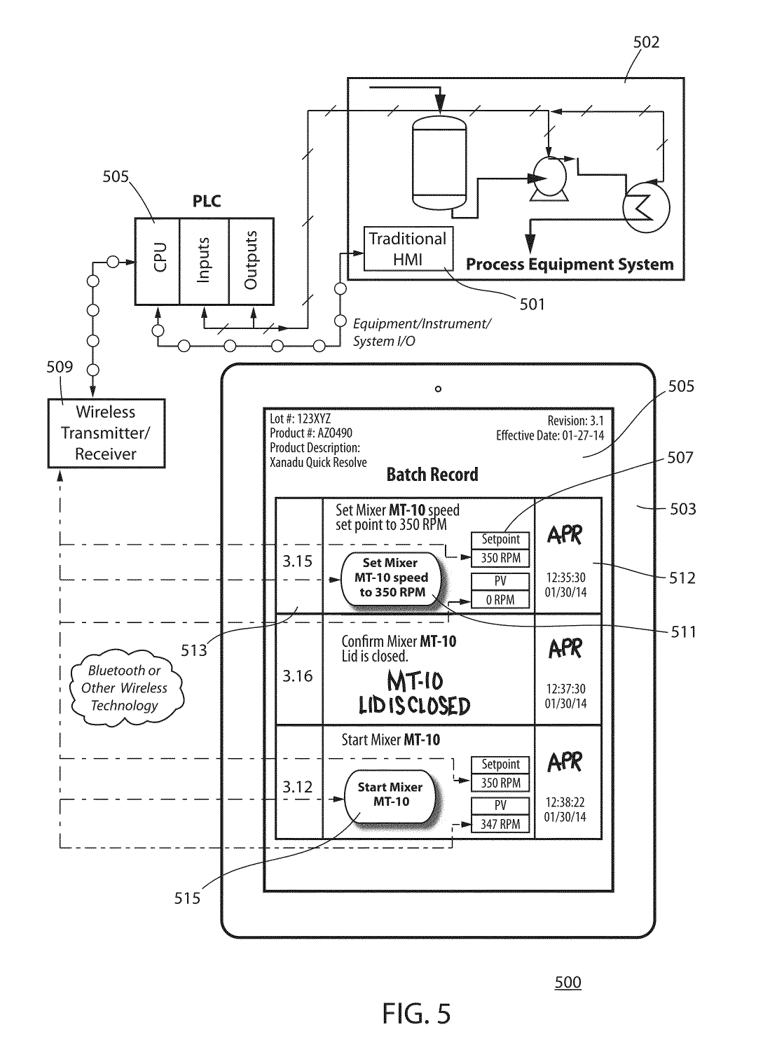

In FIG. 5, an alternative embodiment is representative of manufacturing system 500 that contains various components including equipment, sensors, devices, etc. The process equipment 502 communicates signal information in a bidirectional manner with a programmable logic controller (PLC) 505 typically through hardwired and/or networked input and output connections. Those skilled in the art will recognize that the PLC may be defined as a digital computer used for automation of electromechanical processes, such as control of machinery on factory assembly lines or light fixtures. PLCs are used in many industries and machines. Unlike general-purpose computers, the PLC 505 is designed for multiple inputs and output arrangements, extended temperature ranges, immunity to electrical noise, and resistance to vibration and impact. Programs to control machine operation are typically stored in battery-backed-up or non-volatile memory. A PLC 505 is an example of a hard real-time system, since output results must be produced in response to input conditions within a limited time, otherwise unintended operation will result.

Traditionally, the process system 502 is controlled through a human/machine interface (HMI) 501 where an operator manipulates the test and/or lab equipment by taking actions at the HMI 501. When in use, production is typically documented in a paper based “batch record” with data visually observed and handwritten into the batch record. Alternatively, data may be generated and printed by a related system, which is then physically attached to the batch record. As seen in FIG. 5, an electronic device 503 is utilized for batch record documentation 505 and provides a display field 507 to the user. The electronic device 503 is also able to communicate through a wireless transmitter/receiver 509 with the system/PLC 505. The PLC 505 includes a central processing unit as well as various input and output modules that receive and send signals to the process system 500. In addition to listing the production steps, the electronic device 503 also allows for process control through manipulation of register values of the PLC 505.

At the appropriate step in the batch record, the operator is presented with the appropriate control interface for the step being executed. As an example, if a mixer setpoint is specified, the operator can enter the setpoint by pushing/selecting visually represented areas on the display such as a “virtual” button 511 that is presented in the batch record display. In many cases, a confirmation step will be required to complete the action to prevent unwanted operations due to inadvertent “touches” of the device. Upon completion of the setpoint step, several methods are available for documenting completion of the step including a time stamp 512. Other examples of operator interface with the system through the batch record include documentation of visual steps 513 and additional manipulation of equipment (Start/Stop) 515 at the appropriate batch record step. As seen in FIG. 5, data is communicated to and from the PLC 505 which enables the user to enter their handwritten initials in a data field 517. As noted herein, this entry of handwritten initials or other indicia works to verify and confirm completion of steps of a particular test necessary in meeting the codified rules of regulatory compliance.

An important aspect of the communication system 100 and communication system 500 and embodiments of the inventions as described herein, relate to the protection of combinations of handwritten data entry with any one (or more) of forms of electronic data entry. This might be best referred to as “hybrid documentation” which marries the entry of handwritten data with stored, processed and/or sensor output data. For example, as described with regard to FIGS. 3 and 4, handwritten data can be used in combination with expected test data so to provide the user/operator a visual indication in a field in the mobile app whether a test has passed or failed. Moreover, the communications system 400 defines a system where executable documents required for compliance are created and then transferred to a data entry device that have multiple modes of data entry. The multiple modes of data entry can include but are not limited to 1) handwritten entries that are digitized and placed within the executable document mimicking handwritten entries on paper; 2) data entries into the documents from technology built into the data entry device (timers-start/stop, GPS location, etc.; 3) data entries from equipment, instruments, etc. that are wirelessly transferred to the data entry device and 4) data entries from equipment, instruments, etc. that are directly connected to the data entry device.

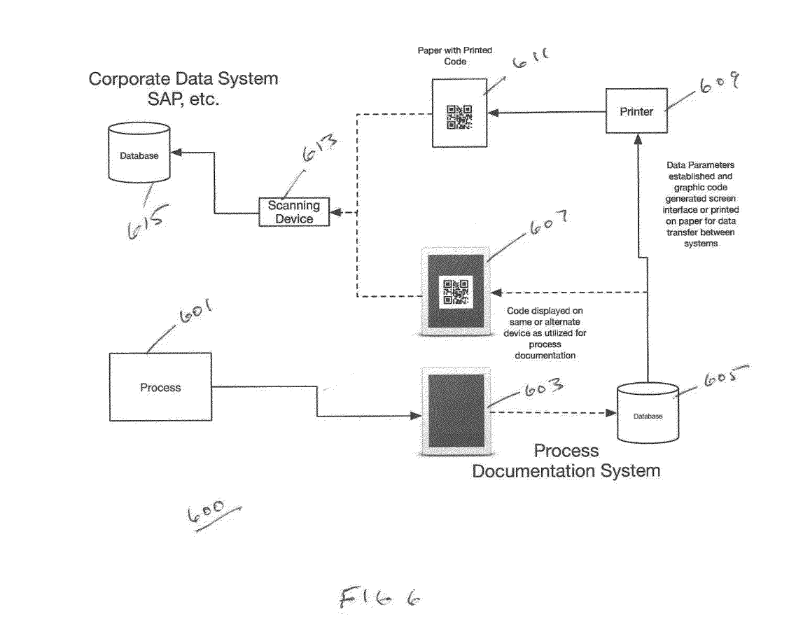

In further embodiments, FIG. 6 is a block diagram illustrating a system for providing data transfer between a process documentation system and a corporate data system. The method of data transfer 600 allows for data transfer between a process documentation system 605 and other corporate data systems such as an Enterprise Resource Planning (ERP) system 615. This method allows for data transfer without directly interconnecting the two systems to one another. More specifically, the system and method entails determining which data needs to be transferred from the process documentation system to the corporate data system. For example, the process 601 is displayed 603 and stored in a process documentation system 605. A one or two dimensional code, such as bar code and/or QR code, is generated that contains the data to be transferred. This code is displayed on the same or alternate device as utilized for the process documentation 607. The code(s) can be displayed either on a system display or by using a printer 609 and displaying them on paper 611. A scanning device connected to the corporate data system can then be utilized to read the printed or displayed codes 613. Thereafter, the appropriate corporate data system fields can be populated with the data provided by the documentation system generated codes where it is stored in a corporate database 615. Thus, those skilled in the art will further recognize that the QR code generated by the process system will have a defined data set. The data set can be defined as a specific process value recorded at some time interval over a predetermined period of time, for example every 60 seconds for 60 minutes. At the end of the 60 minutes, the QR code would be generated and then displayed that includes some identifying information (Instrument ID, Equipment ID, Date, and Start Time) and then the 60 data values that were recorded. Alternatively, a set of process values can be defined where the QR code will include the values of the set at a point in time. In this case, the QR “display” would constantly change (based on the current data sampled) and the data could be populated for that specific time.

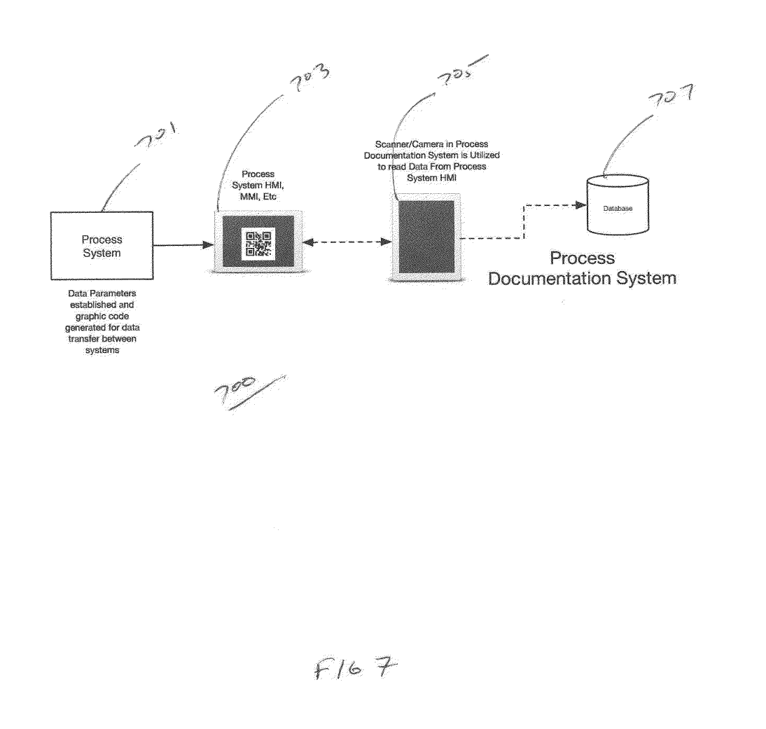

In another embodiment, FIG. 7 illustrates a system and method of data capture that allows for data transfer between a process system and a process documentation system. This system and method 700 allows for data transfer without directly interconnecting the two systems. Initially, it is determined which data needs to be transferred from the process system 701 to the corporate data system 707. A one or two dimensional code, such as bar code and QR code, is generated that contains the data to be transferred. The code(s) can be printed on paper or displayed on a system display 703. A scanning device is then utilized and connected to the process documentation system to read the printed or displayed codes 705. The appropriate process documentation system fields can then be populated with the data provided by the process system generated codes and stored in a process documentation system 707.

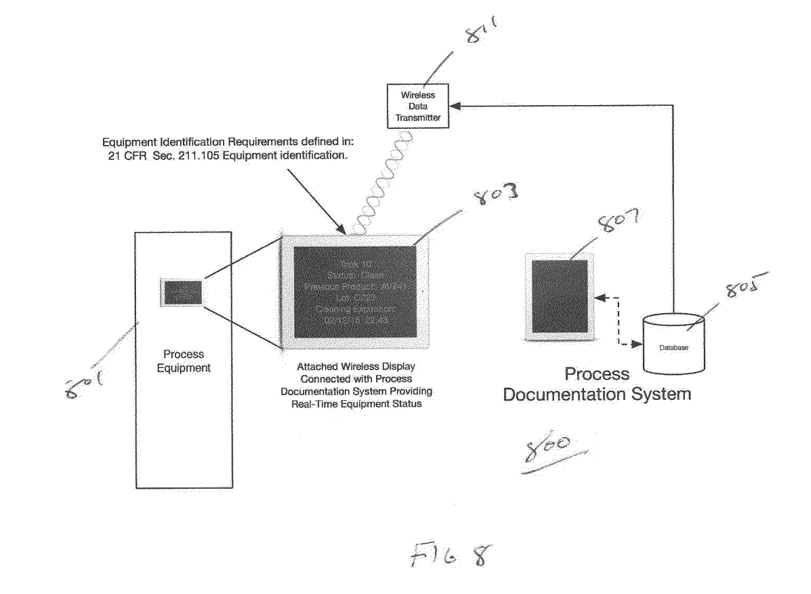

In another embodiment, FIG. 8 illustrates a communications system and method where wireless devices are utilized for communication and data capture by a process documentation system. The communications system 800 provides that a process documentation system 805 and display 807 that is used to identify equipment location and ID number via wireless data that is transmitted by a device 811 attached to process equipment 801. The process equipment typically uses a display 803 that provides real-time equipment status. The system and method uses a wireless transmitter 811 that is programmed to transmit unique data assigned to a specific piece of equipment 801. For example, the transmitter might be an iBeacon® by Apple Corporation. The wireless transmitter 811 is attached to the equipment 801 in an appropriate manner for the environment. The equipment database in the process documentation system 805 is programmed to recognize the transmitted data and identify the equipment from the transmitter data. The location of the equipment 801 is then determined via various methods including unique data transfer and radio strength signal indication (RSSI). The equipment ID# and equipment location in the process documentation system 805 can then be utilized to confirm and validate equipment use and improve compliance.

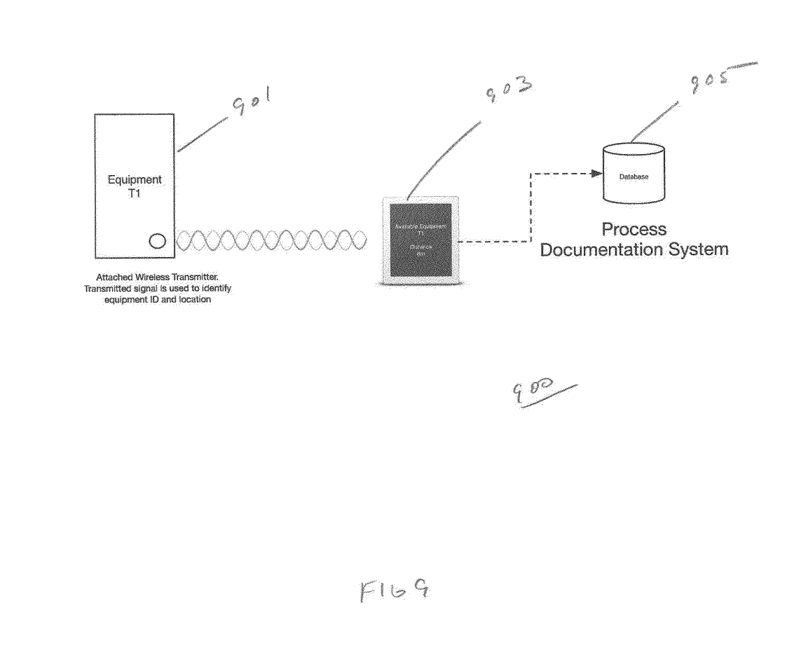

Finally, FIG. 9 illustrates wireless devices utilized to display manufacturing equipment status information required for regulatory compliance. The system 900 includes one or more devices 901 that are attached to manufacturing equipment that will connect to the process documentation system 905. The devices 901 can be programmed to display the required information for regulatory compliance on a mobile device 903 and/or continuously update this information based on changes generated by the process documentation system 905. The advantage of this type of arrangement is that the equipment and status information must be visible and/or documented at all times. The user has an advantage knowing the equipment is production ready by using the status screen on the mobile device 903.

Hence, an important aspect of the communication system 100 and embodiments of the invention as described herein relate to the protection of combinations of handwritten data entry with any one (or more) of forms of electronic data entry. For example, as described with regard to FIGS. 3 and 4, handwritten data can be used in combination with expected test data so to provide the user/operator a visual indication in a field in the mobile app whether a test has passed or failed. Moreover, the communications system 400 defines a system where executable documents required for compliance are created and then transferred to a data entry device that have multiple modes of data entry. The multiple modes of data entry can include but are not limited to 1) handwritten entries that are digitized and placed within the executable document mimicking handwritten entries on paper; 2) data entries into the documents from technology built into the data entry device (timers-start/stop, GPS location, etc.; 3) data entries from equipment, instruments, etc. that are wirelessly transferred to the data entry device and 4) data entries from equipment, instruments, etc. that are directly connected to the data entry device.

Advantages in utilizing embodiments of the mobile app include but are not limited to 1) a perception that data that is system/computer/device generated is more valuable/reliable (data generation); and 2) perception that human documentation and system interaction is more valuable/reliable (decision making). Since persons desiring FDA compliance perceived electronic data to be more valuable, these persons desire electronic documentation. Because use of electric data in such compliance is perceived to be problematic, users are very cautious about converting to electronic documentation, especially for final manufacturing documentation (Electronic Batch Records).

Advantages in utilizing embodiments of the mobile app include but are not limited to 1) a perception that data that is system/computer/device generated is more valuable/reliable (data generation); and 2) perception that human documentation and system interaction is more valuable/reliable (decision making) Since persons desiring regulatory compliance perceive electronic data to be more valuable, these persons desire electronic documentation. Because use of electric data in such compliance is sometimes perceived to be problematic, users are very cautious about converting to electronic documentation, especially for final manufacturing documentation (Electronic Batch Records).

Thus, advantages of embodiments of the present invention include but are not limited to: 1) a combination of hand written documentation, human decision making and system generated data, all available and recorded at one location. Having the system and human recorded data in digital form also allows the data to be analyzed by the system (pass/fail, system calculated values, failure reporting, historical production analytics, etc.) and creates a high comfort level because of the human involvement and interaction; and 2) a system and method for electronically storing batch records. Attempts have been made to create “batch systems”, but they have only been successfully implemented in rare instances. Current offerings attempt to take a control system and create a document that can be utilized as a batch record. When using PLCs and other control systems it is very difficult to manipulate data and present such data in an appropriate batch record format. Additionally, these systems often attempt to have minimal human interaction which makes the system very rigid and susceptible to system errors. This complexity and lack of human decision making creates a system where system errors create processing situations where “recovery” is impossible while maintaining compliance. Because of this, small system errors often result in lost batches. In pharmaceutical processing, a single lost batch can have significant cost implications. The methods as described herein present the ability to interact with the communications system with embedded controls right in the batch record at the appropriate step.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A communications system for performing manufacturing compliance comprising:
at least one mobile device having a display in wireless communication with at least one server using a processor executing a mobile application and configured to perform the steps of:
displaying in a first field in a mobile application the entry of a handwritten value;
comparing a numerical result determined from the handwritten value against an expected numerical value stored in memory or provided by the at least one server;
determining a final value based on the step of comparing; displaying in a second field whether the manufacturing compliance test is regulatory compliant based upon the final value; and
masking the expected numerical value on the display until the handwritten value has been entered.

2. A communications system for performing manufacturing compliance as in claim 1, wherein the expected numerical value is derived from at least one of manufacturing equipment, lab equipment, testing equipment, a programmable logic controller, facility/utilities data and hand held instrumentation.

3. A communications system for performing manufacturing compliance as in claim 1, wherein the at least one mobile device wirelessly communicates with the at least one server.

4. A method using a mobile device having a display and at least one processor for providing results of a manufacturing compliance test configured to perform the steps of:
displaying a first field in the mobile application for allowing the entry of a handwritten value;
comparing a numerical result determined from the handwritten value against an expected numerical value;
determining a final value based on the step of comparing; and
displaying a second field indicating if the manufacturing compliance test is compliant based upon the final value.

5. A method as in claim 4, further comprising the step of:
masking the expected numerical value until the handwritten value has been entered.

6. A method as in claim 4, further comprising the steps of:
converting the numerical results to a two-dimensional electronic code;
utilizing a scanning camera to read the data from a two-dimensional electronic code; and
transmitting the data from the tow-dimensional code to a process documentation system.

7. A computer implemented method for determining manufacturing compliance comprising the steps of:
providing at least one mobile device having a display and processor for executing a software application;
displaying at least one field in the mobile application for providing handwritten information about the results of a FDA compliant test;
masking the expected result until all handwritten information is entered;
comparing a numerical result of the handwritten information to an expected result to provide a final result; and
providing a second field indicating whether the FDA compliant test has passed or failed based upon the final result.

8. A computer implemented method for determining manufacturing compliance utilizing a mobile device having a display and at least one processor for executing a software application configured to perform the steps of:
a) identifying a specific manufacturing quality test to be performed;
b) providing a first data field in the software application for displaying the name of the test;
c) determining a numerical acceptance criteria for the specific manufacturing quality test;
d) providing a second data field in the software application for entering a numerical handwritten result of the manufacturing quality test;
e) converting the handwritten result to a determined numerical value;
f) providing a third data field in the software application for displaying an expected numerical value for the manufacturing quality test;
g) providing a fourth data field in the software application for entering at least one handwritten initial of persons performing the manufacturing quality test;
h) providing a fifth data field in the software application for entering at least one handwritten initial for individuals verifying that the manufacturing quality test has been performed;
i) providing a sixth data field for displaying the determined numerical value that is responsive to entry of the at least one handwritten initial;
j) comparing the determined numerical value to the expected numerical value; and
k) providing a seventh data field indicating a pass or fail indication based upon the step of comparing.

9. A computer implemented method as in claim 8, wherein the specific manufacturing quality test is a regulatory test mandated by law.

10. A computer implemented method as in claim 8, wherein the third field may also be used for providing an above or below indicia of a test result.

11. A computer implemented method as in claim 8, wherein the pass or fail indication is color coded for identification.

12. A computer implemented method as in claim 11, wherein the pass indication is color coded green and the fail indication is color coded red.

13. A computer implemented method as in claim 8, wherein the fifth data field includes a time and date stamp when the at least one handwritten initial was made.

14. A computer implemented method as in claim 8, wherein the sixth data field includes a time and date stamp designating entry of the at least one handwritten initial.

15. A computer implemented method as in claim 8, wherein the identity of the operator performing and documenting steps is verified such that the documentation can include at least one of: handwritten signatures, handwritten initials, digital photos of executor, facial recognition of executor through optical sensor(s), retina scan of executor, fingerprint analysis of executor, barcode scanning of executor documentation, RFID sensors.

16. A computer implemented method of documenting regulatory compliance comprising the steps of:
utilizing a communications system that allows for hybrid documentation for transmitting the hybrid documentation to at least one portable electronic device; and
producing hybrid documentation by combining handwritten data with at least one electronic data collection device.

17. A computer implemented method for documenting regulatory compliance in a manner using hybrid documentation comprising the steps of:
utilizing an electric device to communicate with the wireless communication system in a bidirectional manner;
executing documentation by an operator in bidirectional communication with the communications system such that the documentation data is received from the communications system; and
transmitting data to the communications system at appropriate times as specified by the documentation being executed.

18. A computer implemented method as in claim 16, wherein the step of executing documentation includes the step of collecting data.

19. A computer system for executing a method for transferring hybrid process data from a process system to a process documentation system comprising the steps of:
determining the results of manufacturing compliance using manufacturing compliance data;
transmitting the manufacturing compliance data to an electronic device;
converting the compliance data to a two-dimensional electronic code;
utilizing a scanning camera to read the data from a two-dimensional electronic code; and
transmitting the data from the two-dimensional code to a process documentation system.

20. A computer system as in claim 19 wherein the two-dimensional electronic code is a QR code.
